(19) United States
(12) Patent Application Publication
(10) Pub. No.: US 2010/0163620 A1
(43) Pub. Date: Jul. 1, 2010

(54) Apparatus and Method for Identifying Purchase Items and Storing Target Identifiers

(76) Inventor: Anthony Marsh, Winchester Hants (GB)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/519,352

(22) PCT Filed: Dec. 17, 2007
(86) PCT No.: PCT/GB07/04846

§ 371 Date: Jan. 4, 2010

(30) Foreign Application Priority Data
Dec. 15, 2006 (GB) 0625053.4

(51) Int. Cl. G06K 15/00

(52) U.S. Cl. 235/383

(57) ABSTRACT

An apparatus comprising an input device and a storage element, the input device being operable to identify one or more items for purchase, the apparatus being operable to store one or more target identifiers, the or each target identifier corresponding to a target item and, when at least one of the one or more items matches one or more of the stored identifiers, generate an output accordingly.

### DESCRIPTION OF INVENTION

The present invention relates to an apparatus and method, particularly but not exclusively one of the apparatus comprises a checkout and the method is a method operating a checkout, where the apparatus or method involves identifying items for purchase and comparing those with one or more target identifiers.

It is well known for shops such as supermarkets, and indeed other retail or wholesale establishments, to provide an appropriate station for a cashier, hereinafter referred to as a “checkout” to enable a purchaser's goods to be identified and for the purchaser to pay for those goods. Conventionally, a checkout will include some apparatus for identifying one or more purchased items, such as a bar code scanner. The identifier of the purchased item is then used to identify the item's price, and the price is then used by the checkout to generate the final bill when all items have been scanned. Advantageously, the identifier will identify the item, and this can be used by a retail establishment to keep track of which items have been sold and to identify stock levels, purchasing trends and other information. The checkout may store this information locally, for subsequent update, or may be connected to a central database for the store as a whole.

It is known for stores to encourage custom by means of loyalty cards, where a customer's purchases are recorded. The customer may accumulate points which may be exchanged for discounts or other rewards for shopping at that store or chain of stores. Such schemes, while generally popular, do however require a substantial infrastructure to operate and require the customers to carry an additional card.

### STATEMENTS OF INVENTION

According to a first aspect of the invention, we provide an input device and a storage element, the input device being operable to identify one or more items for purchase, the apparatus being operable to store one or more target identifiers, the or each target identifier corresponding to a target item and, when at least one of the one or more items matches one or more of the stored identifiers, generate an output accordingly.

The apparatus may be operable to store a plurality of identifiers.

The apparatus may be operable to access a database comprising a plurality of identifiers for a plurality of purchasable items and wherein the target identifiers are selected from the plurality of identifiers.

The or each target identifier may be randomly selected from the plurality of identifiers.

The apparatus may be operable to retrieve a price for each identified item, store a total price for all of the identified items, and reduce the total price if at least one of the one or more items matches one or more of the stored identifiers.

The or each target identifier may be selected each time an item is identified.

The or each target identifier may be selected in advance of identifying a plurality of items.

The apparatus may comprise a checkout apparatus.

The checkout apparatus may comprise a bar code scanner to identify the or each item.

The apparatus may comprise a display screen and the output may comprise a display shown on the display screen.

According to a second aspect of the invention we provide a method of operating an apparatus comprising the steps of;
storing one or more target identifiers, the or each target identifier corresponding to a target item,
identifying one or more items for purchase,
comparing the one or more items for purchase with the one or more target identifiers, and
when at least one of the one or more items matches one or more of the stored identifiers, generating an output accordingly.

The method may comprise accessing a database comprising a plurality of identifiers for a plurality of purchasable items and selecting the target identifiers from the plurality of identifiers.

The or each target identifier may be randomly selected from the plurality of identifiers.

The method may comprise retrieving a price for each identified item, storing a total price for all of the identified items, and reducing the total price if at least one of the one or more items matches one or more of the stored identifiers.

The or each target identifier may be selected each time an item is identified.

The or each target identifier may be selected in advance of identifying a plurality of items.

The apparatus may comprise a checkout apparatus.

The invention will now be described by way of example only with reference to the accompanying drawings, wherein:

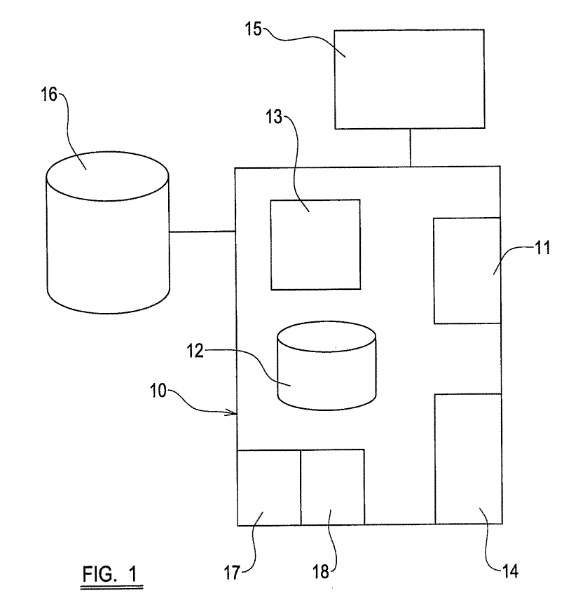

FIG. 1 is a diagrammatic illustration of a check out embodying the present invention,

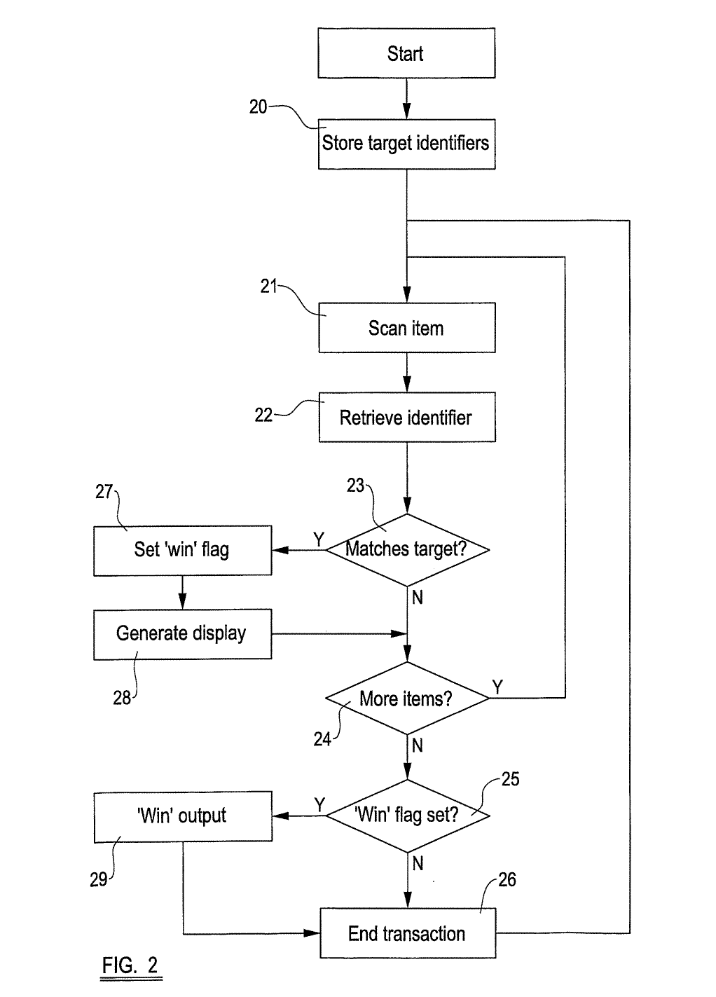

FIG. 2 is a flow chart illustrating a first method of operation of the apparatus of FIG. 1, and

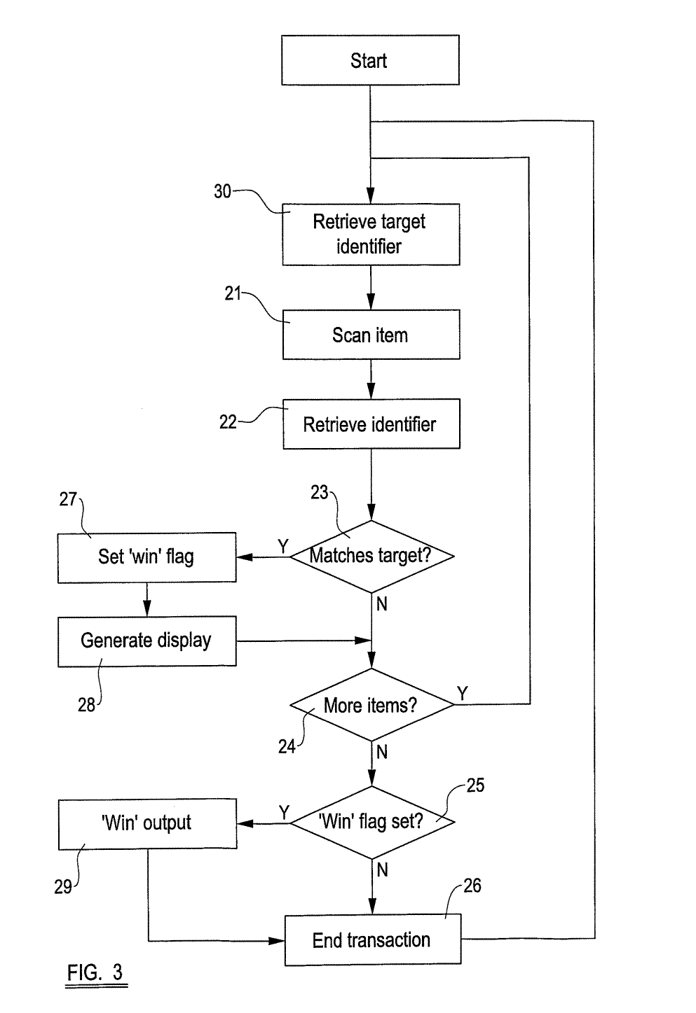

FIG. 3 is a flow chart illustrating a further method of operation of the apparatus of FIG. 1.

Referring now to FIG. 1, an apparatus comprising a check out is illustrated generally at 10. The apparatus comprises an input device 11 for use in identifying purchased items, such as a bar code scanner. It will be apparent that the input device may include any other device as desired, for example and RFID type scanner if the products are provided with RFID tags only as an identifier as appropriate. The check out 10 further has a local data store 12, and a processor 13 operable to receive data from the input device 11 and perform the necessary rule of the check outs for example, retrieving a price for each identified item and generating a final bill when required. The check out 10 may also have an electronic payment terminal, generally shown at 14, and a display 15 which may be controlled by the processor 13 to generate an appropriate desired display, such as identifying the most recent item scanned, the price of that item, a running total, or indeed any other information as desired. The check out 10 may also be connected to a central database 16 which may for example be a database holding an inventory of items held in the store, together with their identifiers, prices and any other information as desired. The check out 10 may also include other devices, such as a loyalty card reader generally shown at 17 and a printer 18 to provide receipts and other printed output as appropriate.

A method of operating the present invention is shown in FIG. 2. At step 20, the checkout stores one or more target identifiers, where the or each target identifier corresponds to a purchasable item. The target identifiers may, for example, be drawn randomly from the database 16, or may be selected by an appropriate operator such as the store manager or provider as otherwise desired. The obtained target identifiers are stored in the local data storage 12 for easy access by the processor 13.

When a customer wishes to buy one or more items, the checkout is then operated in conventional manner, such that at step 21 an item which has been decided to be purchased is scanned, and at step 22, corresponding information is retrieved, either by the database 16 or the local store 12, such as an item identifier or price information. At step 23, the processor 13 checks whether the scanned item identified matches one of the stored target identifiers. If not, then at step 24, if there are more items to scan in the purchase, steps 21 to 23 are repeated. When no more items are to be scanned, then at step 25 the processor 13 checks whether a match has bee found, and if not, at step 26 the final bill is generated. Payment may be obtained, for example, through the electronic payment apparatus, and the checkout 10 is set ready for the next customer and the method repeats.

At step 23, if the scanned item to be purchased does match one of the stored target identifiers, then at step 27 the processor sets a “win” flag and at 28, an appropriate display is generated, for example informing the customer and the checkout operator that a match has been obtained and, for example, that the customer has won a prize. The remainder of the customer's items are scanned as set out above, and then at step 25, as the win flag is set, at step 29 an appropriate output is generated. For example a prize may be identified or the customer's final bill may be reduced or set to zero, or a voucher may be printed out by the checkout, or indeed the prize generated in any other way as desired.

It will be apparent that the one or more target identifiers may be selected at some other point in the method, for example after step 24 when all purchases are complete.

An alternative method is shown in FIG. 3. Steps 21 to 29 are as shown in FIG. 2. However, in this example, prior to scanning each item, a step 30 is performed in which a single target identifier is retrieved, from the database 16 or local store 12. This single target identifier is compared with the identifier for the scanned item as found at step 21. For each subsequent item, the method repeats, and a new target identifier is picked for each item, such that each scanned item is compared with a different randomly selected target identifier rather than a pre-stored list.

Any suitable display may be presented to the customer. For example, a display representing a spinning wheel with logos or other indicator of the target item may be displayed, and when all items have been scanned, the wheel may ‘stop’ with the target item indicated. Alternatively, where there are multiple target identifiers, the display may take the form of a bingo card, for example where multiple matches which complete a row may win.

The apparatus and method described-herein may be used by' a shop as part of a promotion to reward customers, whether as part of a loyalty scheme or otherwise. It will be apparent that by storing target identifiers for certain products, the probability of a customer winning by purchasing a corresponding item may be controlled accordingly. When a customer presents their purchased items at the till, the more items they purchase, the more chances they have of obtaining a match and thus winning, consequently encouraging customers to purchase more items. The rewards may be provided in any form as required, such as reducing or setting to zero the customer's final bill, providing points or other incentives on the customer's loyalty card, printing out vouchers entitling the customer to goods, services or other discounts, or enabling the customer to receive a pre-selected prize item. The apparatus and method thus uses otherwise conventional supermarket checkout apparatus, and the product identifier information which is already provided as part of the apparatus needed to scan and identify products from their barcodes which will already be present in the stores, thus allowing the apparatus and method embodying the invention to be provided simply and inexpensively. It will be apparent that the methods shown in FIGS. 2 and 3 may be varied as desired, and the order of the methods that may be varied as appropriate.

It will be apparent that the invention need not be used solely in physical stores, but may alternatively be used in an Internet store. The selection of target identifiers may be performed, for example, when the customer has completed shopping and started the payment process, and a win may be shown when the payment process has been completed (for example when the customer's credit card has been validated).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An apparatus comprising an input device and a storage element, the input device being operable to identify one or more items for purchase, the apparatus being operable to store one or more target identifiers, the or each target identifier corresponding to a target item and, when at least one of the one or more items matches one or more of the stored identifiers, generate an output accordingly.

2. An apparatus according to claim 1 wherein the apparatus is operable to store a plurality of identifiers.

3. An apparatus according to claim 1 wherein the apparatus is operable to access a database comprising a plurality of identifiers for a plurality of purchasable items and wherein the target identifiers are selected from the plurality of identifiers.

4. An apparatus according to claim 3 wherein the or each target identifier is randomly selected from the plurality of identifiers.

5. An apparatus according to claim 1 operable to retrieve a price for each identified item, store a total price for all of the identified items, and reduce the total price if at least one of the one or more items matches one or more of the stored identifiers.

6. An apparatus according to claim 1 wherein the or each target identifier is selected each time an item is identified.

7. An apparatus according to claim 1 wherein the or each target identifier is selected in advance of identifying a plurality of items.

8. An apparatus according to claim 1 wherein the apparatus comprises a checkout apparatus.

9. An apparatus according to claim 8 wherein the checkout apparatus comprises a bar code scanner to identify the or each item.

10. An apparatus according to claim 8 comprising a display screen and wherein the output comprises a display shown on the display screen.

11. (canceled)

12. A method of operating an apparatus comprising the steps of;
storing one or more target identifiers, the or each target identifier corresponding to a target item,
identifying one or more items for purchase,
comparing the one or more items for purchase with the one or more target identifiers, and
when at least one of the one or more items matches one or more of the stored identifiers, generating an output accordingly.

13. A method according to claim 12 comprising accessing a database comprising a plurality of identifiers for a plurality of purchasable items and selecting the target identifiers from the plurality of identifiers.

14. A method according to claim 13 wherein the or each target identifier is randomly selected from the plurality of identifiers.

15. A method according to claim 12 comprising retrieving a price for each identified item, storing a total price for all of the identified items, and reducing the total price if at least one of the one or more items matches one or more of the stored identifiers.

16. A method according to claim 12 wherein the or each target identifier is selected each time an item is identified.

17. A method according to claim 12 wherein the or each target identifier is selected in advance of identifying a plurality of items.

18. A method according to claim 12 wherein the apparatus comprises a checkout apparatus.

19. (canceled)

20. (canceled)
